(19) United States
(12) Patent Application Publication
(10) Pub. No.: US 2020/0338446 A1
(43) Pub. Date: Oct. 29, 2020

(54) PRESENTING INCENTIVIZED HIERARCHICAL GAMEPLAY

(71) Applicant: Electronic Arts Inc., Redwood City, CA (US)

(72) Inventor: Matthew Harold Linwood EDWARDS, Stratford (CA)

(21) Appl. No.: 16/024,545

(22) Filed: Jun. 29, 2018

(51) Int. Cl. A63F 13/46; A63F 13/798

(52) U.S. Cl. CPC A63F 13/46; A63F 13/798; A63F 2300/556; A63F 2300/61; A63F 2300/558; A63F 2300/204; A63F 2300/5566

(57) ABSTRACT

Methods and systems for presenting incentivized hierarchical gameplay are provided. In one aspect, a method includes receiving a request to form a relationship between a first and a second virtual entity in an electronic simulation environment, the first virtual entity comprising multiple third virtual entity, and at least one third virtual entity is in a hierarchical relationship with another third virtual entity. The method also includes determining whether the relationship between the first and the second virtual entity can be formed. The method also includes forming the relationship. The method also includes associating a set of attributes of the first virtual entity with the second virtual entity. The method also includes increasing a set of strength attributes or decreasing a set of weakness attributes of the first virtual entity as a result of the relationship being formed. The method also includes transmitting a message indicating failure to form the relationship.

### TECHNICAL FIELD

The present disclosure generally relates to improving user interaction with a video game, and more specifically relates to increasing engagement with a video game.

### BACKGROUND

Typically in video games, a single user or a small group of users earn a large number of points and acquire most of the resources in the video game. As these users continue playing the game, they continue to acquire more points and more resources, resulting in acquiring significantly more power and influence over other users in the game. With a significant amount of acquired points and/or resources, the single user or the small group of users face significantly less competition from other users and easily defeat other users, thereby discouraging other users from playing the video game. Over time, if this pattern continues fewer users play the video game, resulting in less engagement with the video game.

### SUMMARY

The present disclosure provides for a game mode that results in incentivizing users of the video game to engage in forming relationships with other users, thereby increasing engagement with the game.

According to one embodiment of the present disclosure, a computer-implemented method is provided. The method includes receiving, from a device of a first user, a request to form a relationship between a first virtual entity and a second virtual entity in an electronic simulation environment, where the first virtual entity comprises multiple third virtual entities, and where at least one virtual entity of the multiple third virtual entities is in a hierarchical relationship with another virtual entity of the multiple third virtual entities. The method also includes determining, based on a rule set, whether the relationship between the first virtual entity and the second virtual entity can be formed. The method also includes forming the relationship in the electronic simulation environment between the first virtual entity and the second virtual entity in response to determining that the relationship between the first entity and the second entity can be formed. The method also includes associating a set of attributes of the first virtual entity with the second virtual entity in response to determining that the relationship between the first entity and the second entity can be formed. The method also includes increasing a set of strength attributes of the first virtual entity as a result of the relationship being formed between the first virtual entity and the second virtual entity, or decreasing a set of weakness attributes of the first virtual entity as a result of the relationship being formed between the first virtual entity and the second virtual entity in response to determining that the relationship between the first entity and the second entity can be formed. The method also includes transmitting, to the device of the first user, a message indicating failure to form the relationship in response to determining that the relationship between the first entity and the second entity cannot be formed.

According to one embodiment of the present disclosure, a non-transitory computer readable storage medium is provided including instructions that, when executed by a processor, cause the processor to perform a method. The method includes receiving, from a device of a first user, a request to form a relationship between a first virtual entity and a second virtual entity in an electronic simulation environment, where the first virtual entity comprises multiple third virtual entities, and where at least one virtual entity of the multiple third virtual entities is in a hierarchical relationship with another virtual entity of the multiple third virtual entities. The method also includes determining, based on a rule set, whether the relationship between the first virtual entity and the second virtual entity can be formed. The method also includes forming the relationship in the electronic simulation environment between the first virtual entity and the second virtual entity in response to determining that the relationship between the first entity and the second entity can be formed. The method also includes associating a set of attributes of the first virtual entity with the second virtual entity in response to determining that the relationship between the first entity and the second entity can be formed. The method also includes increasing a set of strength attributes of the first virtual entity as a result of the relationship being formed between the first virtual entity and the second virtual entity, or decreasing a set of weakness attributes of the first virtual entity as a result of the relationship being formed between the first virtual entity and the second virtual entity in response to determining that the relationship between the first entity and the second entity can be formed. The method also includes transmitting, to the device of the first user, a message indicating failure to form the relationship in response to determining that the relationship between the first entity and the second entity cannot be formed.

According to one embodiment of the present disclosure, a system is provided that includes means for storing instructions, and means for executing the stored instructions that, when executed by the means, cause the means to perform a method. The method includes receiving, from a device of a first user, a request to form a relationship between a first virtual entity and a second virtual entity in an electronic simulation environment, where the first virtual entity comprises multiple third virtual entities, and where at least one virtual entity of the multiple third virtual entities is in a hierarchical relationship with another virtual entity of the multiple third virtual entities. The method also includes determining, based on a rule set, whether the relationship between the first virtual entity and the second virtual entity can be formed. The method also includes forming the relationship in the electronic simulation environment between the first virtual entity and the second virtual entity in response to determining that the relationship between the first entity and the second entity can be formed. The method also includes associating a set of attributes of the first virtual entity with the second virtual entity in response to determining that the relationship between the first entity and the second entity can be formed. The method also includes increasing a set of strength attributes of the first virtual entity as a result of the relationship being formed between the first virtual entity and the second virtual entity, or decreasing a set of weakness attributes of the first virtual entity as a result of the relationship being formed between the first virtual entity and the second virtual entity in response to determining that the relationship between the first entity and the second entity can be formed. The method also includes transmitting, to the device of the first user, a message indicating failure to form the relationship in response to determining that the relationship between the first entity and the second entity cannot be formed.

According to one embodiment of the present disclosure, a system is provided including a memory storing sequences of instructions, and a processor configured to execute the sequences of instructions, which when executed, causes the processor to perform receiving, from a device of a first user, a request to form a relationship between a first virtual entity and a second virtual entity in an electronic simulation environment, where the first virtual entity comprises multiple third virtual entities, and where at least one virtual entity of the multiple third virtual entities is in a hierarchical relationship with another virtual entity of the multiple third virtual entities. The execution of the sequences of instructions also causes the processor to perform determining, based on a rule set, whether the relationship between the first virtual entity and the second virtual entity can be formed. The execution of the sequences of instructions also causes the processor to perform forming the relationship in the electronic simulation environment between the first virtual entity and the second virtual entity in response to determining that the relationship between the first entity and the second entity can be formed. The execution of the sequences of instructions also causes the processor to perform associating a set of attributes of the first virtual entity with the second virtual entity in response to determining that the relationship between the first entity and the second entity can be formed. The execution of the sequences of instructions also causes the processor to perform increasing a set of strength attributes of the first virtual entity as a result of the relationship being formed between the first virtual entity and the second virtual entity, or decreasing a set of weakness attributes of the first virtual entity as a result of the relationship being formed between the first virtual entity and the second virtual entity in response to determining that the relationship between the first entity and the second entity can be formed. The execution of the sequences of instructions also causes the processor to perform transmitting, to the device of the first user, a message indicating failure to form the relationship in response to determining that the relationship between the first entity and the second entity cannot be formed.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate aspects of the subject technology, and together with the description serve to explain the principles of the subject technology. In the drawings:

FIG. 1 illustrates an example architecture for incentivized hierarchical gameplay.

FIG. 2 is a block diagram illustrating the example clients and servers from the architecture of FIG. 1 according to certain aspects of the disclosure.

FIGS. 3A-3B illustrate example processes for incentivized hierarchical gameplay using the example server of FIG. 2.

FIG. 4 illustrates an example user interface in an incentivized hierarchical gameplay system presented to a user.

FIG. 5 is a block diagram illustrating an example computer system with which the clients and servers of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

Many video games provide virtual entities whose power and influence over other virtual entities is typically dependent upon the points and resources acquired by the users controlling the virtual entities. Users playing these games generally end up acquiring the points and resources by playing the games over a period of time. However, a few users end up acquiring significantly more points and resources than other users, resulting in gaining significant competitive advantages over other users. This results in new users being unable to compete with the users that have already acquired the significant amount of points and resources. The new users engage less with the video game and fewer new users start playing the video game. One approach to increasing engagement of users is to incentivize users of the video games to form relationships with other users, and share the resources and points associated with the virtual entities controlled by the users.

The techniques and methods described herein provide for automatically forming relationships in an electronic simulation environment between virtual entities based on a rule set. The techniques and methods described herein also provide for automatically adjusting configuration of a video game, which may include sharing of points and resources associated with the virtual entities that are in relationship with each other, based on a rule set, thereby incentivizing a user of a virtual entity to form relationships with other virtual entities. Thus, new users are able to engage with a video game for longer durations when playing the video game and a single user or a small group of users have less power to churn out new users from playing the video game.

### Example System Architecture

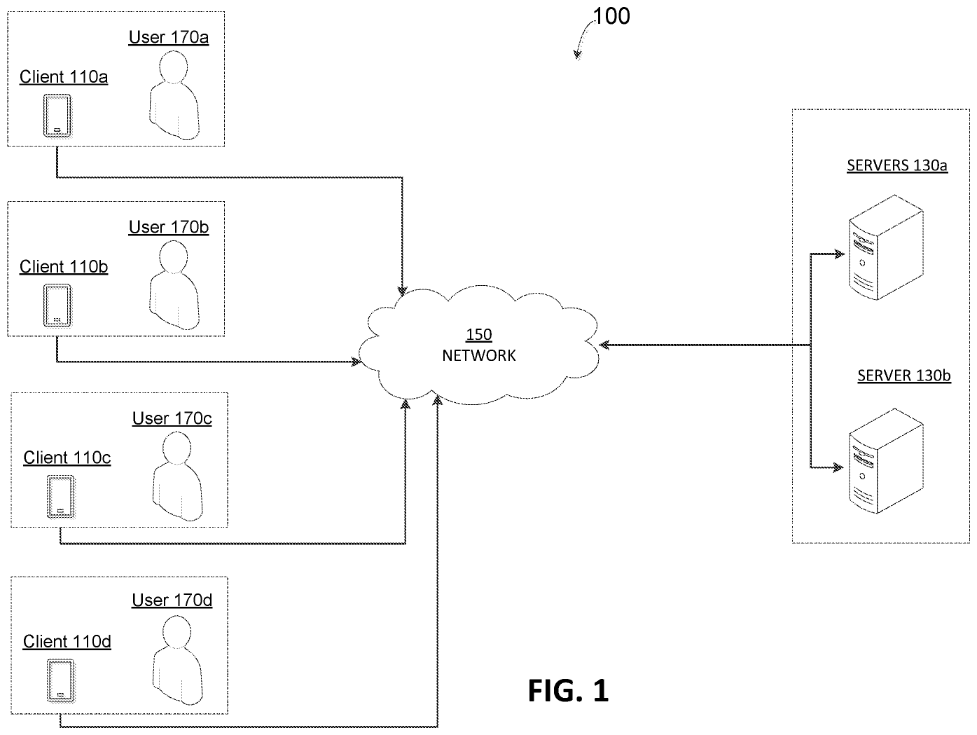

FIG. 1 illustrates an example architecture 100 for presenting an incentivized hierarchical gameplay. The architecture 100 includes clients 110a, 110b, 110c, 110d, generally referred to herein as clients 110, and servers 130a, 130b, generally referred to herein as servers 130 connected over a network 150. Users 170a, 170b, 170c, 170d, generally referred to herein as users 170, interact with respective clients 110 and transmit data, including instructions, to servers 130.

Servers 130 may be configured to be cloud computing servers that provide platform-as-a-service (PaaS) and/or software-as-a-service (SaaS) services. Examples of platforms and/or software hosted by the servers 130 include, but are not limited to, video game applications and related video game data, including virtual-world data related to users 170. Examples of virtual-world data related to users 170 includes, but are not limited to, users 170 account information, preferences, video game state data saved by users 170, and the like. Video game state data associated with users 170 includes selections made by users 170 within a particular instance of a video game. For example, if the video game is a type of a strategy simulation video game, then the video game state data associated with users 170 includes character selections made by the users 170, in-game resources, such as character armor, character weapons, and the like, earned by the users 170, saved instances of the video game, and the like. In some implementations, for purposes of load balancing, multiple servers 130 may host the above described applications and data. The servers 130 can be any devices having an appropriate processor, memory, and communications capability for hosting data and video game applications including hosting video game applications as a service.

The clients 110 include one or more computing devices, including but not limited to, mobile devices (e.g., a smartphone or PDA), tablet computers, laptop computers, desktop computers, video game consoles, and/or other devices capable of running a video game. In some implementations, the clients 110 may include a storage medium that includes logic to provide a game simulation. In some implementations, the game simulation provided by the client 110 is an electronic video game that may be executable by one or more processors of the client 110. The game simulations are each individually stored on media, such as flash memory, stead-state memory, removable media storage, game cartridges, or other storage media. In some implementations, instances of a game application may be downloaded and stored on storage media of the clients 110. The clients 110 are configured to transmit data to the servers 130 in response to inputs received from users 170. In some implementations, clients 110 are configured to download video game data associated with the user 170 and stored on the servers 130, upon starting the instance of the game application being hosted on the client 110.

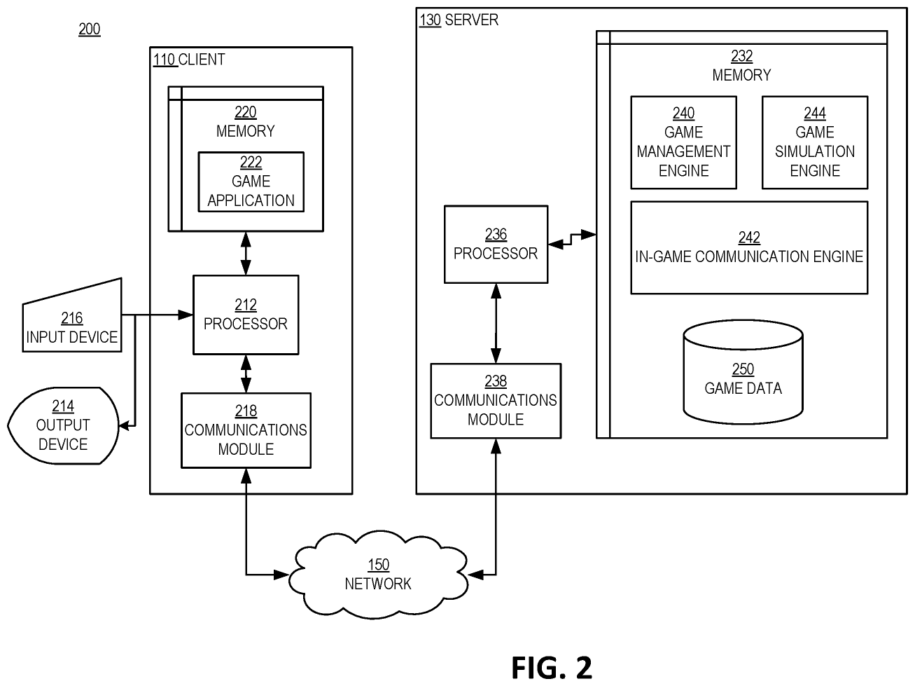

A game application may be also referred to as a game code and/or a game program. A game application should be understood to include software code that the client 110 uses to provide a game simulation for a user to interact with (or play). A game application may include software code that informs the client 110 of processor instructions to execute, but may also include data used in the playing of the game, such as data relating to constants, images and other data structures created by the game developer. A user 170 interacts with the game application and the client 110 through user input/output (I/O) devices. The clients 110 may each execute a separate instance of a game application. Additional details of clients 110 are described below with reference to FIG. 2.

The clients 110 and the servers 130 are communicatively coupled to each other over the network 150. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

### Example System for Incentivized Hierarchical Gameplay

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The server 130 includes a memory 232, a processor 236, and a communications module 238. The memory 232 of the server 130 includes a game management engine 240, an in-game communication engine 242, and a game simulation engine 244. The processor 236 of the server 130 is configured to execute instructions, such as instructions physically coded into the processor 236, instructions received from software in the memory 232, or a combination of both. The game environment engine 240 receives inputs from users 170 via clients 110 over the network 150. Examples of inputs received by the game environment engine 240 include, but are not limited to, selection of plays, players, teams, and the like. The game environment engine 240 is configured to save the user's selections, changes to configuration data of the video game, and provide the data to other engines within memory 232, such as the game simulation engine 244, in-game communication engine 242, game environment engine 246, and/or save data related to the user's selections in game data repository 250.

The game simulation engine 244 is configured to generate multiple simulation attributes of a game between two users, such as user 170a, 170b. The simulation attributes of a game include managing requests for relationships, resources, and the like, from users of virtual entities in the electronic simulation environment of the video game, interactions between one or more virtual entities within the electronic simulation environment of the video game. As described herein, the term “relationship,” refers to an association between two virtual entities. For example a single character in the video game may form a relationship with another character in the video game. The relationship between two virtual entities may be hierarchical, such that one virtual entity is in a lower tier than another virtual entity or is a sub-virtual entity of another virtual entity. For example, a single character may become part of a social collective, where the single character can be assigned a rank within the social collective, and based on the rank, the single character falls within the organizational structure of the social collective, thus forming a hierarchical relationship with the social collective virtual entity. Similarly, a social collective may form a relationship with another social collective, such that the first social collective becomes sub-part or sub-group of the second social collective.

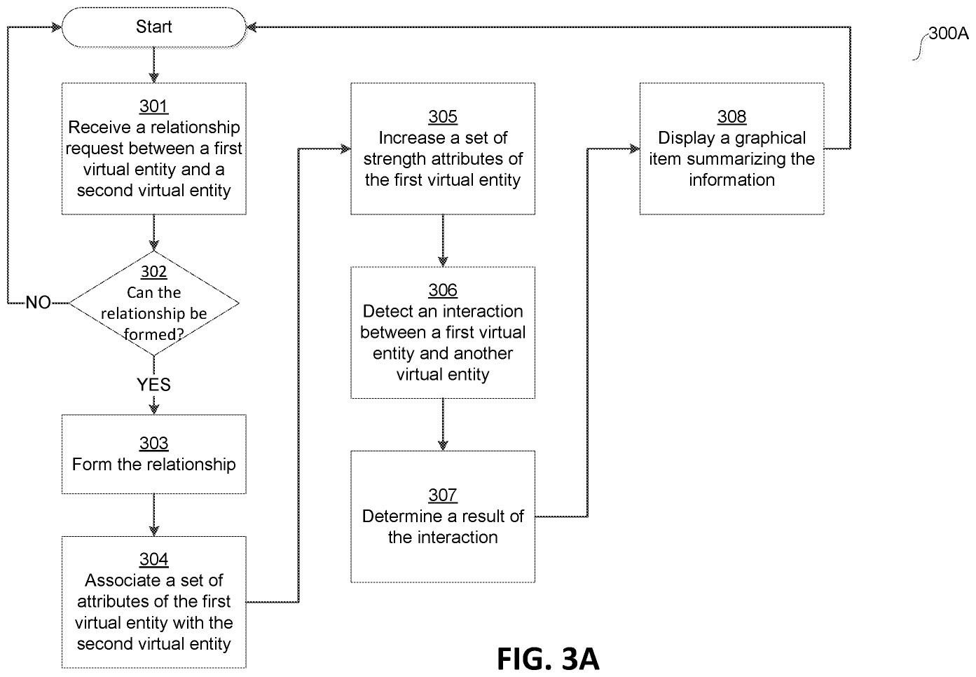

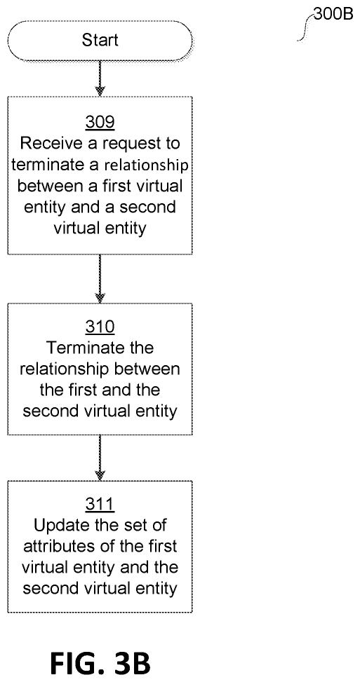

As described herein, the term “interaction,” refers to any type of interaction between two virtual entities, where one virtual entity is eventually declared a winner. Examples of interactions between the virtual entities include, but are not limited to, battles between the virtual entities, negotiation or agreements between the virtual entities, and the like. The game simulation engine 244 determines a winner of an interaction based on attributes associated with the virtual entities. Examples of attributes associated with virtual entities, include but are not limited to, strength attributes, weakness attributes, overall points earned by the virtual entity, and the like. The game simulation engine 244 is configured to store the associations between the virtual entities within a data storage unit, such as game data 250. Additional details of generation of requests, and interactions between virtual entities are described below with reference to FIG. 3A.

The game simulation engine 244 is configured to transmit data to users specifying information related to the state of the game including a summary of the actions taken by one or more users of the game, and a summary of actions or events that occurred while the game progressed in a simulation. The game simulation engine 244 is configured to update points earned by various virtual entities for all users in the game in real-time or near real-time. In response to a virtual entity forming a relationship with another virtual entity, the game simulation engine 244 is configured to aggregate attributes of one virtual entity with the attributes of the other virtual entity. For example, if a virtual entity, such as a character within the video game, forms a relationship with a social collective of the video game, then the points earned by the character virtual entity are aggregated with the points earned by the social collective virtual entity. In doing so, the game simulation engine 244 enhances the strength of the social collective virtual entity and incentivizes users of the game to engage in more social interactions with other users within the game by forming relationships within the game. Additional details of aggregating attributes, and/or increasing or decreasing attributes of a virtual entity are provided below with reference to FIG. 3A.

The game simulation engine 244 is configured to determine whether a game has ended or not for a particular user 170 based on the health level of the virtual entity controlled by the user 170. The health level of a virtual entity may be indicated by health indicator associated with the instance of the virtual entity controlled by the user 170. Examples of the health indicator of the virtual entity include, but are not limited to, a numerical value, a state, and the like. For example, each virtual entity may be associated with a health indicator, which is a numerical value that ranges across multiple numerical values, such as a number between 0-100, where each numerical value is associated with a health level of the virtual entity. In some implementations, the game simulation engine 144 is configured to determine that a virtual entity ceases to exist if the health level of the virtual entity is below a threshold level. For example, if the health indicator of the virtual entity is zero, then the game simulation engine 144 determines that the virtual entity ceases to exist and determines that the game for the user 170 has ended. The game simulation engine 144 is configured to present corresponding graphical user interfaces (GUIs) on the client 110 of the user 170 that indicate the health of the virtual entity. At the end of a game, the game simulation engine 144 is configured to present corresponding graphical user interfaces (GUI) on the client 110 of the user 170, such as an end of game GUI that provides a summary of the game and achievements of the one or more virtual entities controlled by the user. In some implementations, virtual entities are configured to not have an end of life state, and the game simulation engine 244 may be configured to determine that the game for the user 170 that controls the virtual entity has not ended even if the health indicator of the virtual entity is zero.

The in-game communication engine 242 is configured to present GUIs configured to receive and display communications, referred to herein as “communication GUI,” from one user to another user that are playing in the game, such as user 170a. The in-game communication engine 242 is configured to present communication suggestions to the users of the game based on the state of the game. For example, the in-game communication engine 242 may present graphical icons for certain resources to quickly enable users to trade resources or purchase resources from each other. Similarly, the in-game communication engine 242 may present other types of messages that indicate an action or an event that occurs during the game. For example, the in-game communication engine 242 may display a message indicating that a user has requested to engage in an interaction with a virtual entity controlled by or associated with another user. For example, the in-game communication engine 242 may display a message on client 110a of user 170a indicating that user 170c is requesting to form a relationship with the virtual entity controlled by the user 170a. In some implementations, the in-game communication engine 242 receives instructions from other modules or engines within server 130. For example, in response to a virtual entity earning a resource or a successfully forming a relationship with another virtual entity, the game simulation engine 244 may transmit instructions to the in-game communication engine 242 to display the graphical message corresponding to the virtual entity earning the resource or successfully forming the relationship.

The game data repository 250 may be usable to store variables and other game and processor data as needed. The game data repository 250 may be used to retain data that is generated during the play of a game and portions thereof may also be reserved for frame buffers, game state and/or other data needed or usable for interpreting user input and generating game displays. The game data repository 250 also may include game code and/or data that provide game rules, prerecorded poses/paths, environmental settings, character movement constraints, and character models.

The client 110 includes a processor 212, the communications module 218, and the memory 220 that includes a game application 222. The game application 222 may be a streaming engine and/or simulation engine, or physically coded instructions that execute a simulation of a virtual universe with various virtual entities. The client 110 also includes an input device 216, such as a keyboard, mouse, touchscreen and/or game controller, and an output device 214, such as a display. The processor 212 of the client 110 is configured to execute instructions, such as instructions physically coded into the processor 212, instructions received from software in the memory 220, or a combination of both. The processor 212 of the client 110 executes instructions from the game application 222 causing the processor 212 to transmit user inputs and data from the game application 222 to the server 130 via the communications module 218. The user 170, via the game application 222, being executed on client 110, interacts with the game management engine 240, the in-game communication engine 242, and the game simulation engine 244.

The client 110 executing the game simulation may have memory (e.g., 220) for game state, character states and scene object storage. Character states include storage for a current pose of characters being animated. In some aspects, the game data repository 250 also includes the game state, character states and scene object storage. The client 110 provides for user input to control aspects of the game according to game rules. The game rules may be specified in instruction form on media stored in the client 110 and/or accessed from the server 130 via the game data repository 250. The game rules specify a set of rules that define outcomes of an interaction between two virtual entities. In some implementations, the game rules may specify when a relationship between two virtual entities can be formed. In some implementations, the game rules may specify that a relationship between two virtual entities can be formed if a rank associated a virtual entity is not above a threshold rank within the video game. For example, the game rules may specify that if a virtual entity is ranked among the top 5 ranks within the video game, then the virtual entity cannot form a relationship with another virtual entity. In some implementations, a rank associated with the virtual rank can be a rank associated with a user of the game. In some implementations, a rank associated with the virtual rank can be based on points earned by the user controlling the virtual entity.

In some implementations, the game rules may specify that a relationship between two virtual entities can be formed if the formation of the relationship does not lead to a circular relationship. For example, if a first virtual entity forms a relationship with a second virtual entity, and the first virtual entity has formed a relationship with a third virtual entity, then the game simulation engine 244, based on the game rules that prevent the formation of circular relationships between virtual entities, prevents a relationship to be formed between the second virtual entity and the third virtual entity. In some implementations, the game rules may specify that a virtual entity cannot form relationships with two virtual entities simultaneously at the same tier level of a hierarchical relationship. A hierarchical relationship is a relationship where one virtual entity is in a subordinate relationship with another virtual entity, such as a parent-child relationship, master-slave relationship, leader-member relationship, commander-private relationship, and the like. Two virtual entities are at the same tier level with a first virtual entity, if the first virtual entity will be in a subordinate relationship with both the virtual entities. For example, if a first virtual entity is in a subordinate relationship with a second virtual entity, then if the first virtual entity attempts to form a relationship with a third virtual entity where the first virtual entity will be in a subordinate relationship with the third virtual entity, then the game simulation engine 244 may determine that the third virtual entity and the second virtual entity are at the same tier level with respect to the first virtual entity, and the game simulation engine 244, based on the game rules, may deny or prevent the relationship between the first virtual entity and the third virtual entity from being formed.

The game rules may specify a depth of hierarchy for a virtual entity. A depth of hierarchy may be based on the number of tier levels of the hierarchical relationship, and the game rules may specify that a depth of hierarchy may be limited to a threshold number of tier levels. For example, if the game rules specify that a virtual entity can only have 3 tier levels in a hierarchical relationship, then a first virtual entity, which is in a subordinate relationship with a second virtual entity, which is in a subordinate relationship with a third virtual entity, cannot form a relationship with a fourth virtual entity that, where the fourth virtual entity will be in a subordinate relationship with the first virtual entity since the third virtual entity will then have four tiers of a hierarchical relationship, thus exceeding the threshold number of tiers, 3.

In some implementations, the game rules may specify that a virtual entity cannot form a relationship with another virtual entity if combining one or more attributes of the virtual entities exceeds a threshold level for the one or more attributes. For example, the game rules can specify that a virtual entity cannot form a relationship with another virtual entity if the points associated with each virtual entity, when aggregated, is greater than a threshold point amount. Similarly, the game rules can specify that a first virtual entity cannot form a relationship with a second virtual entity if strength of the first virtual entity, such as attacking power of the first virtual entity, when combined with the strength of the second virtual entity, exceeds a threshold level for attacking power. Another example of the game rules is where the game rules specify that a virtual entity cannot form a relationship with another virtual entity if a weakness of one of these virtual entities is decreased below a threshold level for the virtual entity. In some implementations, the game rules can specify a condition that a first virtual entity cannot form a relationship with a second virtual entity if the difference between the level of an attribute one or more attributes of a first virtual entity and a second virtual entity is not greater than threshold level. For example, the game rules can specify that a first virtual entity cannot form a relationship with a second virtual entity if the difference between the points associated with the first virtual entity and the points associated with the second virtual entity is not greater than a threshold amount of points.

Other examples of game rules include rules for earning points, possible inputs, actions/events, movement in response to inputs, and the like. The client 110 may include a separate graphics processor (not shown). As described above, the client 110 may be a handheld video game device, a console (special purpose) computing system for operating computer games such as video games, a general-purpose laptop or desktop computer, or other suitable system.

The techniques described herein may be implemented as method(s) that are performed by physical computing device(s), as one or more non-transitory computer-readable storage media storing instructions which, when executed by computing device(s), cause performance of the method(s), or, as physical computing device(s) that are specially configured with a combination of hardware and software that causes performance of the method(s).

FIG. 3A and FIG. 3B illustrate example processes 300A and 300B, respectively, of incentivized hierarchical gameplay for a user 170 using a computing device executing an instance of the game application, such as client 110 executing game application 222 of FIG. 2. For explanatory purposes, the example processes 300A and 300B are described herein with reference to the processors 212 and 236 of FIG. 2. However, the example processes 300A and 300B are not limited to the processors 212 and 236 of FIG. 2, and one or more blocks of the example processes 300A and 300B may be performed by one or more other components of the server 130, including game management engine 240, game simulation engine 244, or in-game communication engine 242. Further for explanatory purposes, the blocks of the example processes 300A and 300B are described herein as occurring in serial, or linearly. However, multiple blocks of the example processes 300A and 300B may occur in parallel. In addition, the blocks of the example processes 300A and 300B need not be performed in the order shown and/or one or more of the blocks of the example processes 300A and 300B need not be performed. For purposes of explanation of the subject technology, the processes 300A and 300B will be discussed in reference to FIG. 2.

Referring now to FIG. 3A, at step 301, the game simulation engine 244 of server 130 receives a relationship request to form a relationship between a first virtual entity and a second virtual entity. The relationship request may be received from a client 110 of a user 170. In some implementations, the first virtual entity may comprise other virtual entities. For example the first virtual entity may be a virtual social collective or group. As described herein, the virtual social group may be referred to herein as a “guild.” As described herein, a “guild” is a virtual entity that has one or more virtual entities as members, and if it has more than one virtual entity as a member, then one of the virtual entities may be in a hierarchical relationship with the other virtual entities in the guild. In some implementations, the second virtual entity may be a coalition. As described herein, a “coalition” is a virtual entity that has one or more guilds as members, and it if has more than one guild as a member, then one of the guilds may be in a hierarchical relationship with the other guilds in the coalition.

In some implementations, the relationship request may be received from another module stored in the memory 232, such as the game management engine 240. The server 130 may present or cause a GUI, configured for generation of a relationship request to form a relationship between a first virtual entity and a second virtual entity, on a client, such as a client 110a in order to allow a user, such as user 170a, to generate the relationship request. The user, such as user 170a, may generate the relationship request for his or her virtual entity, such as a character of the strategy game, using the GUI displayed on the client 110a. The user 170a generated relationship request is transmitted to the server 130 via network 150. In some implementations, the user generated relationship requests are stored in a storage unit, such as game data 250, and a user may retrieve one or more generated relationship requests from the game data 250 and view the generated relationship requests on a client 110. In some implementations, the GUI displaying the relationship request displays information related to first virtual entity and the second virtual entity. The information related to the first virtual entity and the second virtual entity may include strength and weakness attributes of the first virtual entity and the second virtual entity.

At step 302, the game simulation engine 244, determines whether the requested relationship can be formed. The game simulation engine 244 may determine whether the requested relationship can be formed based on a rule set. In some implementations, the rule set can specify one or more conditions under which a relationship can be formed between two virtual entities in an electronic simulation environment, such as a video game. For example, the rule set may specify a condition that a first virtual entity can form a relationship with a second virtual entity if the overall point difference between the virtual entities is not greater than a threshold amount of points. If the game simulation engine 244 determines that the relationship cannot be formed (“NO” at step 302), then the game simulation engine 244 returns to the start of the example process 300. If the game simulation engine 244 determines that the relationship can be formed (“YES” at step 302), then the game simulation engine 244 continues to step 303.

At step 303, the game simulation engine 244 forms the relationship between the first virtual entity and the second virtual entity. In some implementations, the game simulation engine 244 forms a relationship between the first virtual entity and the second virtual entity by associating an identifier of the first virtual entity with an identifier of the second virtual entity and stores the association in a data storage unit of server 130, such as game data 250. In some implementations, the game simulation engine 244 causes the server 130 to display a GUI to the client 110 of the user 170 that provides information of a successful relationship being formed between the first virtual entity and the second virtual entity. In some implementations, the displayed GUI also provides information related to the first and second virtual entities, such as strengths of the first and second virtual entities, the resources owned by the first and second virtual entities, the amount of game points accumulated by the first and second virtual entities.

At step 304, the game simulation engine 244 associates a set of attributes of the first virtual entity with the second virtual entity. As described above, a set of attributes of a virtual entity include points earned by the user of the virtual entity, strengths, weakness, resources, and the like, associated with the virtual entity. For example, if the virtual entity is a character in a strategy game, the set of attributes can specify various strengths of the character, such as special moves, power moves, and the like. Similarly, the set of attributes can specify various weaknesses of the character, such as particular characters in the video game, particular resources that the character is vulnerable to, and the like. As described above, a virtual entity can be a guild, and if the virtual entity is a guild, the set of attributes for the guild can specify various resources owned or associated with the members of the guild, total points for the guild, which may be calculated based on the points of the members of the guild, and the like. Similarly, the set of attributes for the guild can specify various weaknesses for the guild, such as particular virtual items or virtual weapons in the video game that the members of the guild may be vulnerable to, and the like. A virtual entity maybe a coalition, as described above, and the set of attributes for the coalition can specify various resources owned or associated with the members of the coalition, total points for the coalition, which may be calculated based on the points of the members of the coalition, and the like. Similarly, the set of attributes for the guild can specify various weaknesses for the coalition, such as particular virtual items or virtual weapons in the video game that the members of the coalition may be vulnerable to, and the like. In associating the set of attributes of the first virtual entity and the second virtual entity, the game simulation engine 244 may add the points associated with the first virtual entity to the total points of the second virtual entity. As described above, the total points of a virtual entity increases the influence of the virtual entity over other virtual entities. Additionally, the total points of the virtual entity allows the virtual entity to accumulate resources that increase one or more strengths of the virtual entity and improves one or more weaknesses of the virtual entity.

In step 305, the game simulation engine 244 increases a set of strength attributes of the first virtual entity. In some implementations, the game simulation engine 244 increases the set of strength attributes of the first virtual entity by associating the strength attributes of the second virtual entity with the first virtual entity, such that in a next interaction that the first virtual entity has with another virtual entity, the game simulation engine 244 utilizes the strength attributes of the second virtual entity that are associated with the first virtual entity. In some implementations, the game simulation engine 244 improves a set of weakness attributes of the first virtual entity by associating a set of weakness attributes of the second virtual entity with the weakness attributes of the first virtual entity.

In step 306, the game simulation engine 244 detects an interaction with between the first virtual entity and another virtual entity, such as a fourth virtual entity. In some implementations, the fourth virtual entity may be another character of the video game. In some implementations, the fourth virtual entity may be a virtual social group, created in the electronic simulation environment and existing within the video game. As described herein, the virtual social group may be referred to herein as a “guild.” As described above, a “guild” is a virtual entity that has one or more virtual entities as members, and if it has more than one virtual entity as a member, then one of the virtual entities may be in a hierarchical relationship with the other virtual entities in the guild. The interaction detected by the game simulation engine 244 may be various types of simulated interactions, including, but not limited to, negotiation simulation, communication simulation, a battle simulation, a simulated competitive task, and the like. In step 307, the game simulation engine 244 determines a result of the interaction between the first virtual entity and the fourth virtual entity. The game simulation engine 244 is configured to determine the result of the interaction between the first virtual entity and the fourth virtual entity based on the attributes associated with the first virtual entity and the fourth virtual entity. For example, the game simulation engine 244, based on strength attributes of the first virtual entity, may determine an overall strength attribute of the first virtual entity, and, based on strength attributes of the fourth virtual entity, may determine an overall strength attribute of the third virtual entity. The game simulation engine 244 may determine the result of the interaction by comparing the overall strength attribute of the first virtual entity and the fourth virtual entity and may determine the virtual entity with a higher overall strength attribute as the winner.

The game simulation engine 244 may determine the overall strength attributes of a virtual entity based on strength attributes of a virtual entity with which the virtual entity is in a relationship. For example, if the first virtual entity is in a relationship with the second virtual entity and the fourth virtual entity is in a relationship with another virtual entity, then the game simulation engine 244 determines the overall strength attribute of the first virtual entity based on the strength attributes of the second virtual entity and the overall strength attribute of the third virtual entity based on the strength attributes of the another virtual entity. In step 308, the game simulation engine 244 causes the server 130 to display a GUI that presents information related to the interaction between the first virtual entity and the fourth virtual entity on the clients 110 of users 170 of the first virtual entity and the fourth virtual entity that presents information related to the interaction. After step 308, the game simulation engine 244, returns the process back to the start of the process 300.

Referring now to FIG. 3B, at step 309, the game simulation engine 244 of server 130 receives a request to terminate a relationship between a first virtual entity and a second virtual entity. At step 310, the game simulation engine 244 terminates the relationship between the first virtual entity and the second virtual entity. In some implementations, the game simulation engine 244 may be configured to determine whether a relationship can be terminated between the first virtual entity and the second virtual entity based on a set of rules. For example, the set of rules may specify that a relationship between two virtual entities cannot be terminated if either of the virtual entity is engaged in an interaction with another virtual entity at the time the request for termination is received. Similarly, the set of rules may specify that a relationship between two virtual entities cannot be terminated until an interaction in which one of the virtual entities is engaged in is completed or over. In some implementations, the game simulation engine 244 may be configured to determine whether a relationship exists between the first virtual entity and the second virtual entity prior to terminating the relationship.

The game simulation engine 244 may be configured to terminate a relationship between two virtual entities by deleting the association between the unique identifiers of the virtual entities, which indicates that a relationship was formed between the two virtual entities. In some implementations, the game simulation engine 244 may store relationship associations between virtual entities in a data storage unit, a database, or a data structure, such as a table, in memory, and the game simulation engine 244 may be configured to update the data storage unit, the databased, and/or the data structure after the deleting the association between the unique identifiers of the two virtual entities.

At step 311, the game simulation engine 244 updates the set of attributes associated with the first virtual entity and the second virtual entity after the termination of the relationship between the two virtual entities. In some implementations, the game simulation engine 244 may store a copy of the set of attributes of a virtual entity prior to that virtual entity forming a relationship with another virtual entity, and after the termination of the relationship, the game simulation engine 244 may be configured to update the set of attributes associated with the first virtual entity and the second virtual entity back to their respective set of attributes prior to the forming of the relationship between the first virtual entity and the second virtual entity.

In some implementations, the game simulation engine 244 may be configured to track the increases in the set of strength attributes and the decreases in set of weakness attributes for each of the virtual entities between which the relationship was formed, and the game simulation engine 244 may be configured to decrease each strength attribute in the set of strength attributes by the corresponding amount of increases and increase each weakness attribute in the set of weakness attributes by the corresponding amount of decreases. In some implementations, the game simulation engine 244 may configured to revert all changes to various strength and weakness attributes back to their respective levels prior to forming the relationship. In some implementations, the game simulation engine 244 may be configured to remove or delete any associations formed between the two virtual entities as a result of forming a relationship between the two virtual entities.

FIGS. 3A and 3B set forth example processes 300A and 300B of incentivizing users, such as users 170, to form relationships in an electronic simulation environment of a video game using a computing device executing an instance of the game application, such as client 110, executing game application 222 of FIG. 2, and/or a server, such as server 130, executing one or more modules or engines of the video game, such as the game management engine 240, in-game communication engine 242, or game simulation engine 244. An example will now be described using the example processes 300A and 300B of FIG. 3A and FIG. 3B to describe how a player of the video game, controlling a virtual entity within the video game, will be incentivized to form a relationship with another virtual entity of the video game. An example of the video game may be a strategy video game, such as Star Wars: Rise to Power by Electronic Arts. An example of the client 110 is a smartphone and a user 170 using the smartphone to play the video game is the video game player. The video game player of Star Wars: Rise to Power controls a character within the Star Wars: Rise to Power, and the video game player progresses through the game earning points, collecting resources, and/or attacking or deceiving one or more other players of Star Wars: Rise to Power. To maximize the chances of earning the points, collecting the resources, and/or successfully attacking or deceiving other players of the video game, the video game player is incentivized to enter into relationships with other video game players, thereby forming a guild of one or more video game characters, or other coalitions of guilds within the video game. As described above, a “coalition” is a virtual entity that has one or more guilds as members, and it if has more than one guild as a member, then one of the guilds may be in a hierarchical relationship with the other guilds in the coalition. The process begins by proceeding to step 301, where a request to form a relationship between a character, a guild, or a coalition controlled by the video game player and a character, a guild, or a coalition controlled by another video game player is received at a server hosting an instance of the Star Wars: Rise to Power or certain modules or engines of Star Wars: Rise to Power. The request to form the relationship may be generated by the video game player by using the touch-screen of his or her smartphone, for example, by touching icons displaying options to form relationships with other characters, guilds, or coalitions of Star Wars: Rise to Power. The smartphone of the video game player is communicatively coupled to the server receiving the request to form the relationship from the video game player.

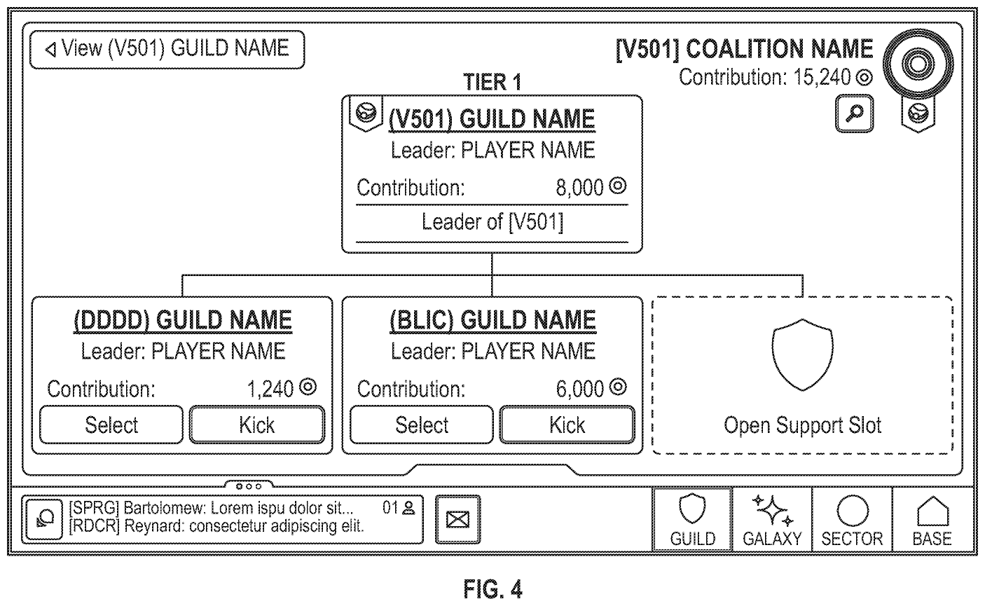

The process 300A continues to step 302, where the server determines whether the requested relationship can be formed. The server determines whether the requested relationship can be formed based on a set of game rules. If the server determines that the relationship cannot be formed, then the process 300 continues to the start of the process. If the server determines that the relationship can be formed between the character, guild, or coalition controlled by the video game player and a character, guild, or coalition controlled by another video game player, then the process continues to step 303. At step 303, the server forms the relationship and may display a graphical user interface (GUI) of the video game on the smartphone of the video game player the formation of the relationship between the character, guild, or coalition of the video game player and a character, guild, or coalition of another video game player. An example screenshot of such a GUI is the FIG. 4, which displays multiple guilds that are entered into a relationship with each other forming a larger coalition. As shown in FIG. 4, each guild may be assigned at a particular tier of the coalition and a single guild may be assigned to be the leader of the coalition. The GUI may display other information about the video players, individual virtual entities within the guilds, the guilds, and the coalitions, such as a names, attributes, and the like within the relationship, as shown in FIG. 4.

The process continues to step 304, where the server associates points earned by the video game player, the strengths of the character, the guild, or the coalition, such as attacking power and the like of the character, the guild, or the coalition, the weaknesses of the character, the guild, or the coalition, such as type of attacks, and the like, to which the character, the guild, or the coalition is most vulnerable. The process continues to step 305, where the server increases a set of strengths of the characters, guilds, or coalitions that formed the relationship and the server may improve a set of weaknesses of the characters, guilds, or coalitions that formed the relationship. The process continues to step 306, where the server detects an interaction between the character, guild, or coalition of the video game player and another character, guild, or coalition. This interaction can be an attack or battle between the characters, the guilds and/or the coalitions, a negotiation between the characters, the guilds, and/or the coalitions, deception by the character, guild, and/or coalition controlled by the video game player and another character, guild, and/or coalition, and other similar actions performed by the video game player or other players.

The process continues to step 307, where the server determines a result of interaction between the character, guild, or coalition controlled by the video game player and another character, guild, or coalition based on the points, strengths, and/or weaknesses associated with the characters, guilds, or coalitions. The server may determine the result based on the points, strengths, and/or weaknesses of the guild or coalition with which the character, guild, or coalition of the video game player is associated and the guild or coalition with which the other characters, guilds, or coalitions are associated. The process 300 continues to step 308, where the server displays a GUI that presents information related to the interaction to the video game player on his or her smartphone, and the process returns to the start of the process 300.

If a request to terminate a relationship between a character, a guild, or a coalition controlled by the video game player and a character, a guild, or a coalition controlled by another video game player is received at the server hosting an instance of the Star Wars: Rise to Power or certain modules or engines of Star Wars: Rise to Power, then the process 300B begins by proceeding to step 309. The request to terminate the relationship may be generated by the video game player by using the touch-screen of his or her smartphone, for example, by touching icons displaying options to terminate relationships with other characters, guilds, or coalitions of Star Wars: Rise to Power. The smartphone of the video game player is communicatively coupled to the server receiving the request to form the relationship from the video game player.

The process 300B continues to step 310, wherein the server terminates the relationship between the character, guild, or coalition controlled by the video game player and the character, guild, or coalition controlled by the other video game player. The server may determine whether the relationship can be terminated based on a set of game rules prior to terminating the relationship, and if the server determines the that the relationship cannot be terminated, then the server may send a message to the smartphone of the videogame player and/or cause a GUI to be displayed on the display of the smartphone of the videogame player that specifies that the relationship cannot be terminated. If the server determines that the relationship can be terminated then the server terminates the relationship between the character, guild, or coalition controlled by the video game player and the character, guild, or coalition controlled by the other video game player.

The process 300B continues to step 311, where the server updates the set of attributes of the character, guild, or coalition controlled by the video game player and the character, guild, or coalition controlled by the other video game player. The server may update the set of attributes of the character, guild, or coalition controlled by the video game player and the character, guild, or coalition controlled by the other video game player by updating the set of attributes to the set of attributes of that existed prior to the formation of the relationship between the characters, guilds, or coalitions. The server may update the set of attributes by decreasing the each strength attribute by the amount it was increased as a result of the relationship being formed, and by increasing each weakness attribute by the amount it was decreased as a result of the relationship being formed. The sever may revert all changes to various attributes of the character, guild, or coalition controlled by the video game player and the character, guild, or coalition controlled by the other video game player back to the levels that prior to formation of the relationship, and the server may remove or delete any associations formed between the character, guild, or coalition controlled by the video game player and the character, guild, or coalition controlled by the other video game player as a result of a relationship being formed between the character, guild, or coalition controlled by the video game player and the character, guild, or coalition controlled by the other video game player.

### Hardware Overview

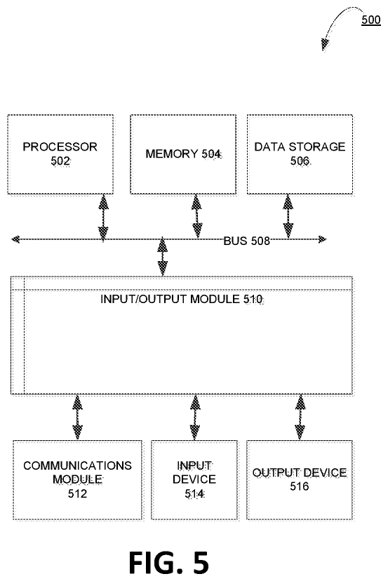

FIG. 5 is a block diagram illustrating an example computer system 500 with which a client 110, such as client 110a, client 110b, client 110c, or client 110d, and a server 130, such as server 130a, and/or server 130b, of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110a, and server 130) includes a bus 508 or other communication mechanism for communicating information, and a processor 502 (e.g., processor 212, 252, 236) coupled with bus 508 for processing information. According to one aspect, the computer system 500 can be a cloud computing server of an IaaS that is able to support PaaS and SaaS services. According to one aspect, the computer system 500 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices, or any other device that incorporates hard-wired and/or program logic to implement the techniques. By way of example, the computer system 500 may be implemented with one or more processors 502. Processor 502 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220, and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry. Expansion memory may also be provided and connected to computer system 500 through input/output module 510, which may include, for example, a SIMM (Single In Line Memory Module) card interface. Such expansion memory may provide extra storage space for computer system 500, or may also store applications or other information for computer system 500. Specifically, expansion memory may include instructions to carry out or supplement the processes described above, and may include secure information also. Thus, for example, expansion memory may be provided as a security module for computer system 500, and may be programmed with instructions that permit secure use of computer system 500. In addition, secure applications may be provided via the SIMM cards, along with additional information, such as placing identifying information on the SIMM card in a non-hackable manner.

The instructions may be stored in the memory 504 and implemented in one or more computer program products, e.g., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices (e.g., input device 216, output device 214). The input/output module 510 can be any input/output module. Example input/output modules 510 include data ports such as USB ports. In addition, input/output module 510 may be provided in communication with processor 502, so as to enable near area communication of computer system 500 with other devices. The input/output module 510 may provide, for example, wired communication in some implementations, or wireless communication in other implementations, and multiple interfaces may also be used. The input/output module 510 is configured to connect to a communications module 512. Example communications modules 512 (e.g., communications module 218, 258, and 238) include networking interface cards, such as Ethernet cards and modems.

The components of the system can be interconnected by any form or medium of digital data communication (e.g., a communication network). The communication network (e.g., communication network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

For example, in certain aspects, communications module 512 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 512 sends and receives electrical, electromagnetic, or optical signals that carry digital data streams representing various types of information. The network link typically provides data communication through one or more networks to other data devices. For example, the network link of the communications module 512 may provide a connection through local network to a host computer or to data equipment operated by an Internet Service Provider (ISP). The ISP in turn provides data communication services through the world wide packet data communication network now commonly referred to as the “Internet.” The local network and Internet both use electrical, electromagnetic, or optical signals that carry digital data streams. The signals through the various networks and the signals on the network link and through communications module 512, which carry the digital data to and from computer system 500, are example forms of transmission media.

Computer system 500 can send messages and receive data, including program code, through the network(s), the network link, and communications module 512. In the Internet example, a server might transmit a requested code for an application program through the Internet, the ISP, the local network, and communications module 512. The received code may be executed by processor 502 as it is received, and/or stored in data storage 506 for later execution.

In certain aspects, the input/output module 510 is configured to connect to a plurality of devices, such as an input device 514 (e.g., input device 216) and/or an output device 516 (e.g., output device 214). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Example output devices 516 include display devices, such as an LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 516 may comprise appropriate circuitry for driving the output device 516 to present graphical and other information to a user.

According to one aspect of the present disclosure, the client 110A can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects, a user of systems and methods as disclosed herein may perform at least some of the steps by accessing a cloud server through a network connection. Further, data files, circuit diagrams, performance specifications, and the like resulting from the disclosure may be stored in a database server in the cloud-computing environment, or may be downloaded to a private storage device from the cloud-computing environment.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, a floppy disk, a flexible disk, a hard disk, magnetic tape, any other magnetic medium, a CD-ROM, a DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire, and fiber optics, including the wires that comprise bus 508. Transmission media can also take the form of acoustic or light waves, such as those generated during radio-wave and infra-red data communications. Furthermore, as used in this specification of this application, the terms “computer,” “server,” “processor,” and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first, second, and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately, or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A computer-implemented method comprising:
receiving, from a device of a first user, a request to form a relationship between a first virtual entity and a second virtual entity in an electronic simulation environment, wherein the first virtual entity comprises a plurality of third virtual entities, wherein at least one virtual entity of the plurality of the third virtual entities is in a hierarchical relationship with another virtual entity of the plurality of the third virtual entities;
determining, based on a rule set, whether the relationship between the first virtual entity and the second virtual entity can be formed, the rule set comprising a condition based on a point difference between the first virtual entity and the second virtual entity;
in response to determining that the relationship between the first virtual entity and the second virtual entity can be formed:
forming the relationship in the electronic simulation environment between the first virtual entity and the second virtual entity;
associating a set of attributes of the first virtual entity with the second virtual entity;
increasing a set of strength attributes of the first virtual entity as a result of the relationship being formed between the first virtual entity and the second virtual entity, or decreasing a set of weakness attributes of the first virtual entity as a result of the relationship being formed between the first virtual entity and the second virtual entity; and
in response to determining that the relationship between the first entity and the second entity cannot be formed:
transmitting, to the device of the first user, a message indicating failure to form the relationship.

2. The computer-implemented method of claim 1, wherein the relationship between the first virtual entity and the second virtual entity is another hierarchical relationship.

3. The computer-implemented method of claim 2, wherein the first virtual entity is in a lower tier than the second virtual entity.

4. The computer-implemented method of claim 1, further comprising:
determining a result of an interaction in the electronic simulation environment between the first virtual entity and a fourth virtual entity based on attributes of the second virtual entity.

5. The computer-implemented method of claim 4, further comprising:
increasing a set of strength attributes of the second virtual entity if the determined result of the interaction indicates that the first virtual entity is a winner.

6. The computer-implemented method of claim 4, further comprising:
decreasing a set of strength attributes of the second virtual entity if the determined result of the interaction indicates that the first virtual entity is not a winner.

7. The computer-implemented method of claim 1, further comprising:
displaying, on the device of the first user, a graphical item representing the relationship in the electronic simulation environment between the first virtual entity and the second virtual entity.

8. The computer-implemented method of claim 1, further comprising:
receiving, from the device of the first user, a second request to terminate the relationship between the first virtual entity and the second virtual entity in the electronic simulation environment;
terminating, based on the second request, the relationship between the first virtual entity and the second virtual entity; and
decreasing the set of strength attributes of the first virtual entity as a result of the relationship being terminated, or increasing the set of weakness attributes of the first virtual entity as a result of the relationship being terminated.

9. The computer-implemented method of claim 8, further comprising:
receiving, from the device of the first user, a third request to form a relationship between the first virtual entity and a fifth virtual entity in the electronic simulation environment;
determining, based on the rule set, whether the relationship between the first virtual entity and the fifth virtual entity can be formed;
in response to determining that the relationship between the first virtual entity and the fifth virtual entity can be formed:
forming the relationship in the electronic simulation environment between the first virtual entity and the fifth virtual entity;
associating the set of attributes of the first virtual entity with the fifth virtual entity;
increasing the set of strength attributes of the first virtual entity as a result of the relationship being formed between the first virtual entity and the fifth virtual entity, or decreasing the set of weakness attributes of the first virtual entity as a result of the relationship being formed between the first virtual entity and the fifth virtual entity.

10. A system comprising:
a memory storing sequences of instructions; and
a processor configured to execute the sequences of instructions, which when executed, causes the processor to perform:
receiving, from a device of a first user, a request to form a relationship between a first virtual entity and a second virtual entity in an electronic simulation environment, wherein the first virtual entity comprises a plurality of third virtual entities, wherein at least one virtual entity of the plurality of the third virtual entities are in a hierarchical relationship with another virtual entity of the plurality of the third virtual entities;
determining, based on a rule set, whether the relationship between the first virtual entity and the second virtual entity can be formed, the rule set comprising a condition based on a point difference between the first virtual entity and the second virtual entity;
in response to determining that the relationship between the first virtual entity and the second virtual entity can be formed:
forming the relationship in the electronic simulation environment between the first virtual entity and the second virtual entity;
associating attributes of the first virtual entity with the second virtual entity; and
in response to determining that the relationship between the first entity and the second entity cannot be formed:
transmitting, to the device of the first user, a message indicating failure to form the relationship.

11. The system of claim 10, wherein the relationship between the first virtual entity and the second virtual entity is another hierarchical relationship.

12. The system of claim 11, wherein the first virtual entity is in a lower tier than the second virtual entity.

13. The system of claim 10, further comprising stored sequences of instructions, which when executed by the processor, cause the processor to perform:
increasing a set of strength attributes of the first virtual entity as a result of the relationship being formed between the first virtual entity and the second virtual entity.

14. The system of claim 10, further comprising stored sequences of instructions, which when executed by the processor, cause the processor to perform:
decreasing a set of weakness attributes of the first virtual entity as a result of the relationship being formed between the first virtual entity and the second virtual entity.

15. The system of claim 10, further comprising stored sequences of instructions, which when executed by the processor, cause the processor to perform:
determining a result of an interaction in the electronic simulation environment between the first virtual entity and a fourth virtual entity based on attributes of the second virtual entity.

16. The system of claim 15, further comprising stored sequences of instructions, which when executed by the processor, cause the processor to perform:
increasing a set of strength attributes of the second virtual entity if the determined result of the interaction indicates that the first virtual entity is a winner.

17. The system of claim 15, further comprising stored sequences of instructions, which when executed by the processor, cause the processor to perform:
decreasing a set of strength attributes of the second virtual entity if the determined result of the interaction indicates that the first virtual entity is not a winner.

18. The system of claim 10, further comprising stored sequences of instructions, which when executed by the processor, cause the processor to perform:
displaying, on the device of the first user, a graphical item representing the relationship in the electronic simulation environment between the first virtual entity and the second virtual entity.

19. A non-transitory machine-readable storage medium comprising machine-readable instructions, which when executed by a processor, cause the processor to perform a method comprising:
receiving, from a device of a first user, a request to form a relationship between a first virtual entity and a second virtual entity in an electronic simulation environment, wherein the first virtual entity comprises a plurality of third virtual entities, wherein at least one virtual entity of the plurality of the third virtual entities are in a hierarchical relationship with another virtual entity of the plurality of the third virtual entities;
determining, based on a rule set, whether the relationship between the first virtual entity and the second virtual entity can be formed, the rule set comprising a condition based on a point difference between the first virtual entity and the second virtual entity;
in response to determining that the relationship between the first entity and the second entity can be formed:
forming the relationship in the electronic simulation environment between the first virtual entity and the second virtual entity, wherein the relationship between the first virtual entity and the second virtual entity is another hierarchical relationship; and
in response to determining that the relationship between the first entity and the second entity cannot be formed:
transmitting, to the device of the first user, a message indicating failure to form the relationship.
